(19) United States
(12) Patent Application Publication
(10) Pub. No.: US 2014/0366704 A1
(43) Pub. Date: Dec. 18, 2014

(54) CARBON FIBER PEDAL HARP

(71) Applicant: David Charles Woodworth, Zirconia, NC (US)

(72) Inventor: David Charles Woodworth, Zirconia, NC (US)

(21) Appl. No.: 13/917,420

(22) Filed: Jun. 13, 2013

(51) Int. Cl. G10D 1/04

(52) U.S. Cl. CPC G10D 1/04
USPC 84/265; 84/264

(57) ABSTRACT

A pedal harp has an upper harp frame which is the pillar and neck parts made as a single piece and a lower harp frame which is the soundbox and soundboard and soundbox parts made as a single piece. The upper harp frame, lower harp frame, faceplates and pedal box are made from a carbon fiber material. This provides lighter weight for the pedal harp, and a stronger, more durable construction.

### BACKGROUND OF THE INVENTION

This invention relates, in general, to the construction of a pedal harp made of a carbon fiber material, with the pillar and neck parts being made as a single piece.

Harps are made in two basic types. A pedal harp which has pedals connected to a mechanism in the neck to vary the vibrating length of the strings, and a “Celtic” harp which does not have pedals. Traditionally harps are made with laminated wood pieces forming the pillar, the neck, various parts of the body and the pedal box. Each of the sections is joined together to make the harp. There are disadvantages to the traditional construction techniques. Wood is heavy making the harp hard to move and easily damaged. The joints between the harp sections tend to flex and loosen over time, which cause the sound of the harp to deteriorate and the harp to deteriorate structurally over time.

The above disadvantages can be overcome by using modern materials such as graphite carbon fiber to construct the elements of the harp, and by constructing those elements in such a way as to combine as many various elements as possible into the smallest number of overall pieces, creating a more unitized type of construction. Others have suggested making harp components from carbon fiber, but have not succeeded in combining the separate components into fewer elements of the pedal harps.

A pedal harp has a mechanism which connects the pedals to a series of discs that, when engaged, vary the vibrating length of the strings. This serves to change the key signature of the harp. The mechanism itself is attached to the underside of the neck of the harp, and consists of a stacked series of linkages which control the discs. The mechanism is controlled by a series of rods which are located inside the pillar. The lower ends of the rods are connected to the pedals in the pedal box, and the upper ends connect to and control the mechanism and linkages. In traditional construction the rods are positioned inside the pillar before the neck is joined to the pillar. Budin (cited below) believes that a pedal harp cannot have the pillar and neck made as a single piece due to the mechanism inside the harp. Budin at column 4, lines 40-43, states: “All the other joins between the components are produced preferably by bonding with epoxy or polyester adhesives. In the particular case of harps having no mechanism, of the “Celtic” type, it will be possible for the pillar 5 to be molded directly with the neck and the cone 10 in order to form a single assembly.”

The instant invention is a solution to this problem.

### DESCRIPTION OF THE PRIOR ART

In the prior art various types of devices have been proposed.

U.S. Pat. No. 4,919,024 issued Apr. 24, 1990 to Budin for a Harp Made From Composite Material. This reference shows harp pieces made of carbon fiber.

U.S. Pat. No. 5,469,770 issued Nov. 28, 1995 to Taylor for a Distributed Load Soundboard System. This reference shows a guitar soundboard made of graphite.

U.S. Pat. No. 5,739,446 issued Apr. 14, 1998 to Bahnson for a Harmonica And Method Of Playing Same. This reference shows a harmonic slide made of graphite.

U.S. Pat. No. 6,005,173 issued Dec. 21, 1999 to Mitchell for a Stringed Musical Instrument. This reference shows a valiha (tube zither) body made of graphite.

U.S. Pat. No. 6,127,615 issued Oct. 3, 2000 to Rosenberg for a Stringed-Instrument Practice Device. This reference shows the base of a stringed instrument practice device made of graphite.

U.S. Pat. No. 6,369,304 issued Apr. 9, 2002 to Tucker for a Selected Percussion Additions For Stringed Musical Instruments. This reference shows a percussion attachment for guitar made of graphite.

U.S. Pat. No. 6,787,688 issued Sep. 7, 2004 to Harmos, et al. for a Musical Instrument. This reference shows an odd stringed instrument made of carbon fiber, and mentions it could apply to harps.

U.S. Pat. No. 7,498,495 issued Mar. 3, 2009 to Mooers for a Harp Sound Box Construction And Method. This reference shows a harp soundboard made of graphite.

U.S. Pat. No. 7,795,513 issued Sep. 14, 2010 to Luttwak for a Stringed Musical Instruments, And Methods Of Making The Same. This reference shows guitar with unitary shell made of carbon fiber. The claims cite a harp guitar with unitary shell, but the carbon fiber variant in not mentioned in connection with the harp guitar. The only mention of the harp guitar is in a single claim.

U.S. Pat. No. 7,884,271 issued Feb. 8, 2011 to Dain for a String-Bridge Interface System And Method. This reference shows carbon fiber sound boards in pianos.

### SUMMARY OF THE INVENTION

The present invention is directed to a pedal harp made of a carbon fiber material, with the pillar and neck parts being made as a single piece.

It is an object of the present invention to provide a new and improved pedal harp that has improved rigidity and stability.

It is an object of the present invention to provide a new and improved pedal harp that is light in weight.

It is an object of the present invention to provide a new and improved pedal harp that is more durable.

It is an object of the present invention to provide a new and improved pedal harp that is more resistant to damage.

It is an object of the present invention to provide a new and improved pedal harp that is more stable and requires less frequent tuning.

It is an object of the present invention to provide a new and improved pedal harp that is resistant to water damage, making it more versatile for playing outdoors or in other difficult environments.

These and other objects and advantages of the present invention will be fully apparent from the following description, when taken in connection with the annexed drawings.

### BRIEF DESCRIPTION OF THE DRAWINGS

FIG. 1 is an exploded view of a prior art pedal harp.

FIG. 2 is an exploded view of the present invention.

FIG. 3 is a cross section view along line A-A of FIG. 2.

### DESCRIPTION OF THE PREFERRED EMBODIMENT

The preferred embodiment herein described is not intended to be exhaustive or to limit the invention to the precise form disclosed. It is chosen and described to best explain the invention so that others, skilled in the art to which the invention pertains, might utilize its teachings.

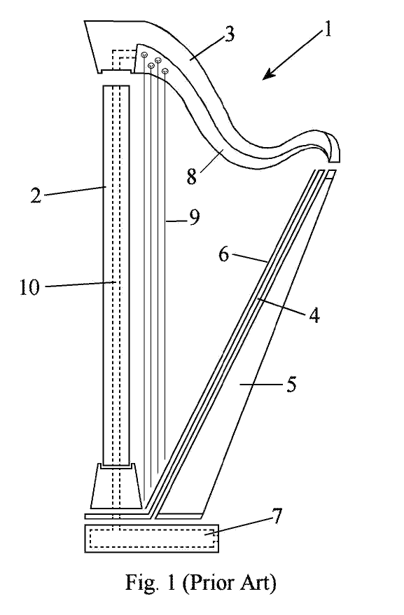

Referring now to the drawings in greater detail, FIG. 1 shows the prior art construction of a pedal harp. Traditionally prior art pedal harps 1 are made with laminated wood pieces forming the pillar 2, the neck 3, various parts of the body 4, including the soundboard 5 and bridge 6, and ii the pedal box 7. Each of the sections is joined together using adhesives and epoxies to make the harp frame. A faceplate 8 is attached to the neck 3, and the strings 9 are connected between the faceplate 8 and soundboard 5.

A pedal harp 1 has a mechanism (not shown) which connects the pedals (not shown) to a series of discs (not shown) that, when engaged, vary the vibrating length of the strings 9. This serves to change the key signature of the harp. The mechanism itself is attached to the underside of the neck 3 of the harp, and consists of a stacked series of linkages (not shown) which control the discs. The mechanism is controlled by a series of rods (not shown) which are located in a hidden passage 10 inside the pillar 2. The lower ends of the rods are connected to the pedals in the pedal box 7, and the upper ends connect to and control the mechanism and linkages. In traditional construction the rods are positioned inside the pillar before the neck is joined to the pillar.

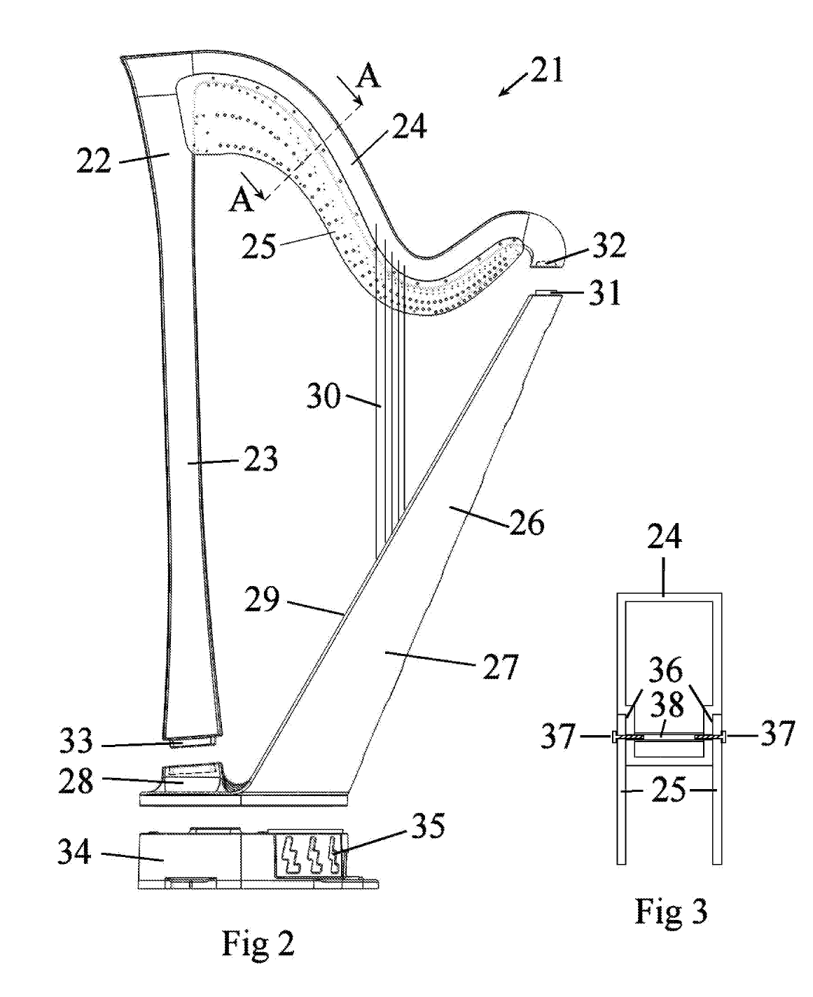

FIG. 2 shows the pieces of the improved pedal harp 21 of the instant invention. The upper harp frame 22, consisting of the pillar 23 and the neck 24, is made as a single piece out of a carbon fiber material. The pillar 23 is hollow to allow the passage of the rods (not shown) from the lower end of the pillar 23 to the neck 24. The faceplates 25, which support the works of the mechanism, are connected to the upper harp frame 22. The faceplates 25 are made of a carbon fiber material. A lower harp frame 26, consisting of the body 27, receiver 28 and sound board 29, is made as a single piece out of the same carbon fiber material as the upper harp frame 22. Harp strings 30 are mounted in a conventional manner between the tuning pins (not shown) on the upper harp frame 22 and the lower harp frame 26. The upper end of the lower harp frame 26 is attached to the upper end of the upper harp frame 22 by means of a broad tenon 31 on the top of the lower harp frame 26, fitting into a receiver 32 in the upper harp frame 22. The lower end of the upper harp frame 22 has a large extension, or tenon 33, which is attached to a receiver 28 at the lower end of the lower harp frame 26. The receiver 28 has a large opening (not shown) to allow the rods to pass through, as does the tenon 33. The tension of the strings 30, about 3000 psi, hold the upper harp frame 22 and the lower harp frame 26 together without the need of any adhesives or mechanical fasteners. The combined assembly of the upper harp frame 22 and the lower harp frame 26 are mounted on a pedal box 34. The pedal box 34 is made of the same carbon fiber material as the other components. The pedal box 34 is provided with openings 35 through which pedals (not shown) are mounted. The pedals are connected to the mechanism by the rods (not shown) which extend via openings in the pedal box 33, the receiver 28 and the tenon 31 up through the hollow pillar 23 into the neck 24 where it is connected to the mechanism. The mechanism, consisting of the faceplates 25 and the mechanism itself (not shown) is of conventional design but is connected to the neck 24 in a new manner with a recess receiver area 36 in the neck 24 into which the faceplates 25 of the mechanism are attached.

FIG. 3 is a view along the cross section A-A of FIG. 2. The neck 24 is hollow. The lower edges of the neck 24 are provided with recesses 36 in which the faceplates 25 are mounted so that the outside surfaces of the faceplates 25 and neck 24 are flush. Bolts 37 fasten the faceplates 25 to the neck 24 using threaded tubes 38. The bolts 37 may be countersunk if so desired. The mechanism extends through the faceplates 25 to connect to the strings 30.

Although the Carbon Fiber Pedal Harp and the method of using the same according to the present invention has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention.

What I claim as my invention is:

1. A pedal harp comprising an upper harp frame, the upper harp frame comprising a pillar and neck formed as a single contiguous construction.

2. The pedal harp as claimed in claim 1, further comprising a lower harp frame body, the lower harp frame comprising a body, receiver and sound board formed as a single contiguous construction.

3. The pedal harp as claimed in claim 2, wherein said upper harp frame and said lower harp frame are held together by the tension of harp strings connected between said upper harp frame and said lower harp frame.

4. The pedal harp as claimed in claim 2, further comprising the single contiguous construction is of a carbon fiber material.

5. The pedal harp as claimed in claim 2, further comprising a faceplate connected to said upper harp frame, said faceplate being made of a carbon fiber material.

6. A pedal harp comprising a lower harp frame body, the lower harp frame comprising a body, receiver and sound board formed as a single contiguous construction.

7. The pedal harp as claimed in claim 6, further comprising an upper harp frame, the upper harp frame comprising a pillar and neck formed as a single contiguous construction.

8. The pedal harp as claimed in claim 7, wherein said upper harp frame and said lower harp frame are held together by the tension of harp strings connected between said upper harp frame and said lower harp frame.

9. The pedal harp as claimed in claim 7, further comprising the single contiguous construction is of a carbon fiber material.

10. The pedal harp as claimed in claim 7, further comprising a faceplate connected to said upper harp frame, said faceplate being made of a carbon fiber material.

11. A pedal harp comprising a lower harp frame body, the lower harp frame comprising a body, receiver and sound board formed as a single contiguous construction, and an upper harp frame, the upper harp frame comprising a pillar and neck formed as a single contiguous construction.

12. The pedal harp as claimed in claim 11, further comprising the single contiguous construction is of a carbon fiber material.

13. The pedal harp as claimed in claim 11, further comprising a faceplate connected to said upper harp frame, said faceplate being made of a carbon fiber material.
